(19) United States
(12) Patent Application Publication
(10) Pub. No.: US 2017/0003544 A1
(43) Pub. Date: Jan. 5, 2017

(54) DISPLAY APPARATUS

(71) Applicant: CANON KABUSHIKI KAISHA, Tokyo (JP)

(72) Inventor: Shingo Yasuda, Yokohama-shi (JP)

(21) Appl. No.: 15/187,519

(22) Filed: Jun. 20, 2016

(30) Foreign Application Priority Data
Jun. 30, 2015 (JP) 2015-132154

(51) Int. Cl. G02F 1/1333; G02F 1/133; G02F 1/1335

(52) U.S. Cl. CPC G02F 1/133385; G02F 1/133308; G02F 1/133608; G02F 1/13306; G02F 2001/13332; G02F 2001/133628

(57) ABSTRACT

A display apparatus according to the present invention includes a display unit configured to display an image, an accommodating unit arranged on a back surface side of the display unit, and configured to accommodate a circuit board for driving the display unit, and an exhaust fan arranged on a back surface side of the accommodating unit. The accommodating unit includes an opening through which air flows in from an outer side of the accommodating unit, and the opening is provided so that an amount of air having flowed in through the opening and flowing on an upper side of the circuit board becomes greater than an amount of air having flowed in through the opening and flowing on a lower side of the circuit board.

### BACKGROUND OF THE INVENTION

Field of the Invention

The present invention related to a display apparatus.

Description of the Related Art

A display apparatus using a liquid crystal panel includes a light source unit for irradiating the liquid crystal panel with light, a control circuit for controlling driving of the liquid crystal panel and the light source unit, and an accommodating unit for accommodating the control circuit. If the control circuit and the accommodating unit are arranged on the back surface side of the light source unit, heat transferred to the back surface side of the light source unit due to the driving of the light source unit is transferred into the accommodating unit, so that temperature within the accommodating unit rises. Air in the heated accommodating unit easily stagnates on the upper side within the accommodating unit.

Japanese Patent Application Laid-Open No. 2014-59502 discloses a technique of releasing heat in an accommodating unit to the outside through natural convection by arranging a tray within the accommodating unit, and further providing opening portions on the lower and upper sides of the accommodating unit.

### SUMMARY OF THE INVENTION

A display apparatus includes a display unit configured to display an image, an accommodating unit arranged on a back surface side of the display unit, and configured to accommodate a first circuit board for driving the display unit, and an exhaust means arranged on a back surface side of the accommodating unit. The accommodating unit includes a first opening through which air flows in from an outer side of the accommodating unit, and the first opening is provided so that an amount of air having flowed in through the first opening and flowing on an upper side of the first circuit board becomes greater than an amount of air having flowed in through the first opening and flowing on a lower side of the first circuit board.

Further features of the present invention will become apparent from the following description of exemplary embodiments (with reference to the attached drawings).

### BRIEF DESCRIPTION OF THE DRAWINGS

FIG. 1 is a cross-sectional view of a display apparatus 1 according to a first exemplary embodiment of the present invention.

FIG. 2A is a back surface perspective view of the display apparatus 1 according to the first exemplary embodiment.

FIG. 2B is an enlarged view of the display apparatus 1 according to the first exemplary embodiment.

FIG. 3 is a schematic diagram illustrating a temperature distribution in an XX cross section in FIG. 1 that is obtainable in the case of driving the display apparatus 1 without driving an exhaust fan 112.

FIG. 4A is a first schematic diagram illustrating a state of openings 114 provided on a front surface of an accommodating unit 110, in the XX cross section in FIG. 1.

FIG. 4B is a second schematic diagram illustrating a state of openings 114 provided on the front surface of the accommodating unit 110, in the XX cross section in FIG. 1.

FIG. 4C is a third schematic diagram illustrating a state of an opening 114 provided on the front surface of the accommodating unit 110, in the XX cross section in FIG. 1.

FIG. 5 is a cross-sectional view illustrating a display apparatus 1 not provided with an opening 114, as a comparative example of the first exemplary embodiment.

FIG. 6 is a cross-sectional view of a display apparatus 1 according to a second exemplary embodiment.

### DESCRIPTION OF THE EMBODIMENTS

Exemplary embodiments of the present invention will be described below using the drawings. In addition, the technical scope of the present invention is defined by the appended claims, and is not limited by the flowing exemplary embodiments. In addition, not all the combinations of features described in the exemplary embodiments are essential for the present invention. The descriptions in this specification and the drawings are examples, and not to be construed as limiting the present invention. Various modifications (including possible combinations of exemplary embodiments) can be made based on the gist of the present invention, and such modifications are not to be excluded from the scope of the present invention. In other words, all the configurations obtained by combining the exemplary embodiments and modified examples thereof are included in the present invention.

### First Exemplary Embodiment

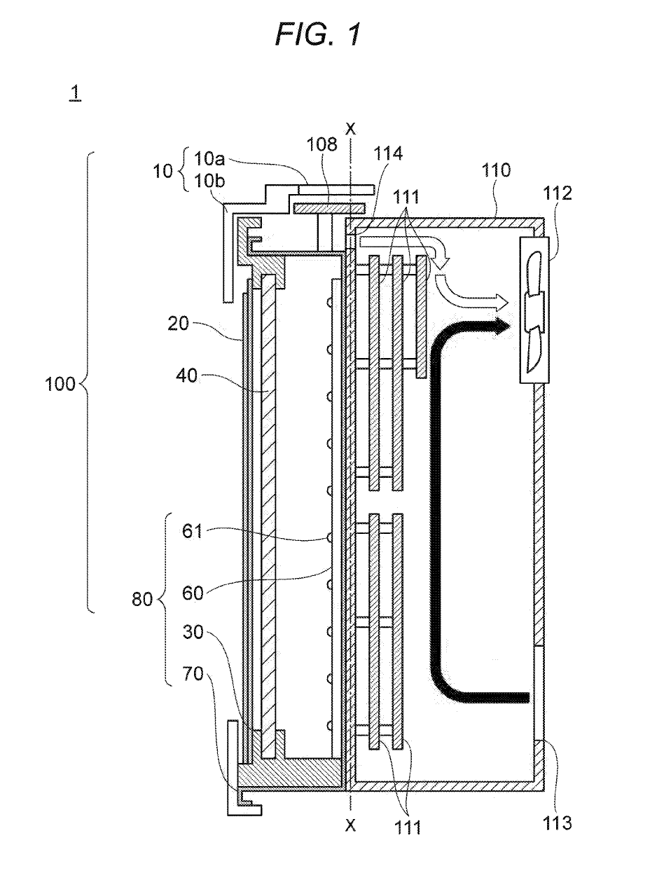

FIG. 1 is a cross-sectional view of a display apparatus 1 according to a first exemplary embodiment of the present invention. The display apparatus 1 includes a display unit 100 for displaying an image, circuit boards 111 for controlling the display unit 100, an accommodating unit 110 arranged on the back surface of the display unit 100, for accommodating the circuit boards 111, and an exhaust fan 112 arranged on the back surface of the accommodating unit 110. A circuit board 108 for driving a liquid crystal panel 20, which will be described later, is fixed on the upper side of the display unit 100 using a plurality of columnar fixing members.

The display unit 100 includes a frame 10, the liquid crystal panel 20, and a light source unit (light source module) 80. The light source unit 80 includes a panel holder 30, an optical sheet 40, a light source board 60, a light source 61, and a backlight housing 70. The liquid crystal panel 20 has a display region for displaying an image, and a peripheral region surrounding the display region. The peripheral region of the liquid crystal panel 20 is sandwiched between the frame 10 and the panel holder 30 of the light source unit 80, so that the liquid crystal panel 20 is fixed.

The light source unit 80 is arranged on the back surface side of the liquid crystal panel 20, and irradiates the liquid crystal panel 20 with light. A plurality of light sources 61 is arranged on the light source board 60. In the present exemplary embodiment, a light emitting diode (LED) is used as the light source 61. In addition, a light source other than the LED can be used as the light source 61. For example, a cold-cathode tube or an electro luminescence (EL) element may be used. In addition, the light sources 61 may be arranged not only on portions on the light source board 60 that correspond to the back surface of the display region of the liquid crystal panel, but also on an end portion of the light source board 60. Light emitted from the light source 61 enters the optical sheet 40.

The optical sheet 40 includes a plurality of optical members. In the present exemplary embodiment, the optical sheet 40 includes a viewing angle enhancement film, a luminance enhancement film, and a luminance diffusion film. Each film is formed of acrylic resin and polyester substrate. The optical sheet 40 adjusts characteristics of light entering the optical sheet 40 from the light source board 60. The optical sheet 40 is fixed by the panel holder 30.

The backlight housing 70 is formed of a steel plate in a box shape having an opening on the side of the liquid crystal panel 20. The light source board 60 is accommodated inside the backlight housing 70. In addition, for causing light emitted from the light source to enter the optical sheet 40, a reflection sheet formed of while PET material and having a plurality of openings for exposing the plurality of light sources 61, or the like may be arranged on the backlight housing 70. Light is emitted from the light source unit 80 onto the display region of the liquid crystal panel 20, so that an image is displayed.

In addition, in the present exemplary embodiment, the description will be given of an example case in which the display apparatus is a liquid crystal display apparatus using a transmissive liquid crystal panel as a display panel. Nevertheless, the display apparatus is not limited to the transmissive liquid crystal display apparatus. For example, the display apparatus may be a reflective liquid crystal display apparatus. Alternatively, the display apparatus may be an MEMS shutter display using a micro electro mechanical system (MEMS) instead of a liquid crystal element.

The frame-shaped frame 10 is arranged on the front surface side of the liquid crystal panel 20. The frame 10 is arranged so that a steel plate with a thickness of 1 mm covers the side surfaces of the liquid crystal panel 20 and the light source unit 80. The frame 10 and the backlight housing 70 are fastened using a screw (not illustrated) to be fixed.

In the present exemplary embodiment, the frame 10 is formed by combining a frame member 10a and a frame member 10b using a combining member (not illustrated). The frame member 10a is arranged so as to cover the upper side of the display unit 100 and the circuit board 108. The frame member 10b is arranged so as to cover the front surface side of the peripheral region of the liquid crystal panel 20. In addition, the frame 10 may be formed of a single member instead of being formed of a plurality of members as described above.

The four sides of the panel holder 30 are individually molded using resin material. Each side of the panel holder 30 is fastened to the backlight housing 70 using a screw (not illustrated), and the panel holder 30 is assembled so that the four sides form a frame shape. The panel holder 30 assembled in a frame shape fixes the liquid crystal panel 20 so as to keep a certain space from the optical sheet 40.

The circuit boards 111 are a display panel control board for controlling a display panel, a light source control board for controlling the driving of the plurality of light sources 61, a power board for supplying power to the light source control board, and the like. The plurality of circuit boards 111 may be arranged on the same plane instead of being arranged in a stacked manner as illustrated in FIG. 1.

The box-shaped accommodating unit 110 arranged on the back surface side of the display unit 100 accommodates the plurality of circuit boards 111. The accommodating unit 110 may be formed of an integrated member through resin molding. Alternatively, the accommodating unit 110 may be formed by combining a plurality of members formed of metal plate, and material and configuration thereof can be arbitrarily selected.

The accommodating unit 110 is provided with a plurality of openings 113, 114, 115, and 116. The opening 113 is provided in the back surface of the accommodating unit 110, on the lower side of a position on the accommodating unit 110 where the exhaust fan 112 is arranged. In addition, the opening 114 is provided in the front surface of the accommodating unit 110, on the upper side of the position on the accommodating unit 110 where the exhaust fan 112 is arranged. The openings 113 and 114 are provided so as to penetrate through the accommodating unit 110 and communicate the inner side and the outer side of the accommodating unit 110.

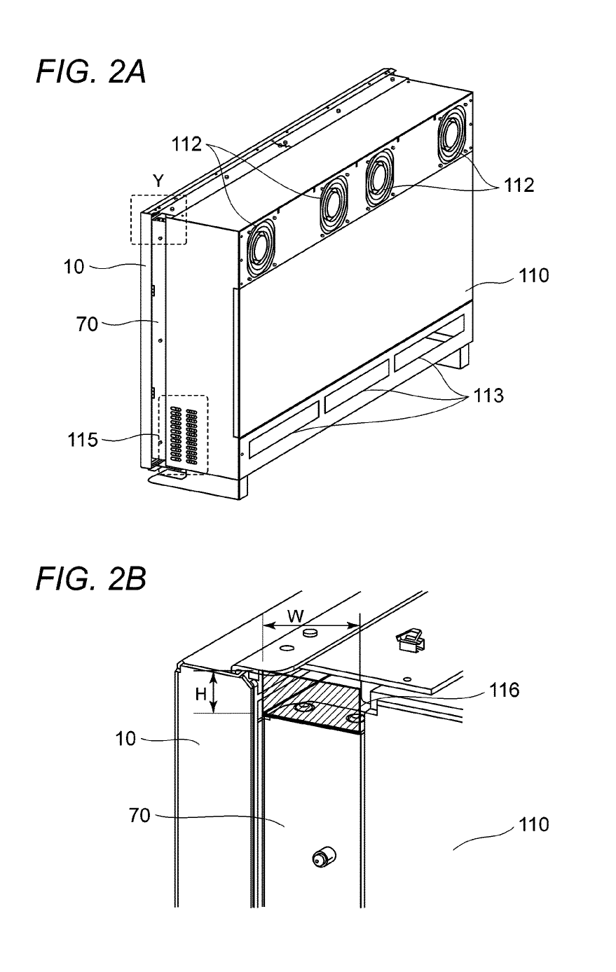

FIGS. 2A and 2B are a back surface perspective view and an enlarged view of the display apparatus 1 according to the first exemplary embodiment. FIGS. 2A and 2B illustrate a state in which the frame member 10a has been detached. Four exhaust fans 112 are arranged on the back surface of the accommodating unit 110. Three openings 113 having a rectangular shape are provided on the back surface of the accommodating unit 110.

In addition, the opening 115 is provided in the side surface of the accommodating unit 110, on the lower side of the positions on the accommodating unit 110 where the exhaust fans 112 are arranged. The opening 115 is formed of a plurality of slit-like openings. In addition, the positions, the numbers, and the shapes of the exhaust fans 112, the openings 113, and the opening 115 are not limited to the above-described configuration, and can be arbitrarily set.

FIG. 2B is an enlarged view of a region defined by a frame Y in FIG. 2A. The opening 116 is provided on the side surface upper side of the display unit 100. The sides of the opening 116 are formed by the upper surface of the backlight housing 70, the front surface of the accommodating unit 110, the frame member 10b, and the circuit board 108. The opening 116 has a height H of 10 mm and a width W of 18 mm. The dimension of the opening 116 is not limited to this, and can be arbitrarily determined depending on the sizes and the like of the backlight housing 70 and the accommodating unit 110. The opening 116 is communicated with a tunnel-shaped air flow path surrounded by the upper surface of the backlight housing 70, the front surface of the accommodating unit 110, the frame member 10b, and the circuit board 108.

In addition, the air flow path may be a space surrounded by the upper surface of the backlight housing 70, the front surface of the accommodating unit 110, the frame member 10b, and the frame member 10a. In this case, the circuit board 108 is arranged in the flow path, so that the circuit board 108 is cooled by outside air flowing from the opening 116 to the opening 114.

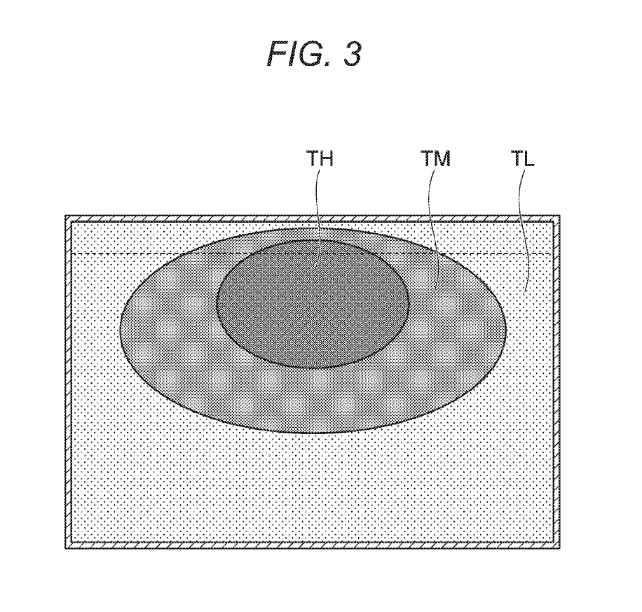

FIG. 3 is a schematic diagram illustrating a temperature distribution in an XX cross section in FIG. 1 that is obtainable in the case of driving the display apparatus 1 without driving the exhaust fan 112. A dotted line in FIG. 3 indicates a position of the upper surface of the backlight housing 70. When the display apparatus 1 is driven, part of heat generated in each of the light sources 61 is transferred to the accommodating unit 110 through the light source board 60 and the backlight housing 70. The heat transferred to the accommodating unit 110 heats air in the accommodating unit 110. In addition, heat generated from the circuit board 111 heats air in the accommodating unit 110.

Since the heated air in the accommodating unit 110 has small density, the air moves toward the upper part of the accommodating unit 110. The front surface of the accommodating unit 110 accordingly has a temperature distribution as illustrated in FIG. 3. Temperatures TH, TM, and TL are in a relationship of TH>TM>TL, and the upper side of a surface where the front surface of the accommodating unit 110 and the back surface of the backlight housing 70 are in contact has higher temperature.

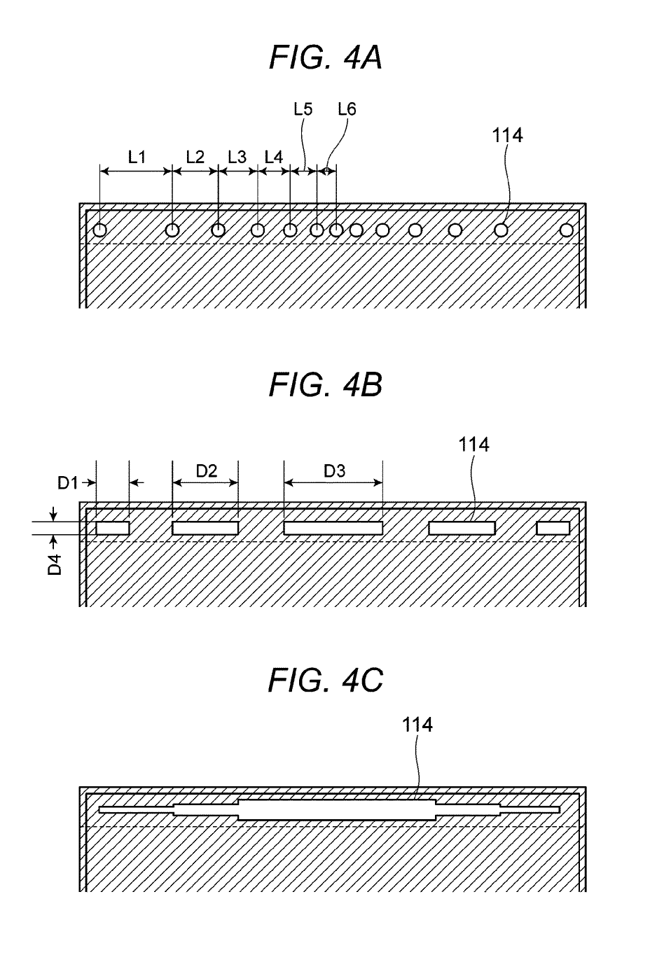

FIGS. 4A to 4C are schematic diagrams illustrating the arrangement of a plurality of openings 114 provided in the front surface of the accommodating unit 110, in the XX cross section in FIG. 1. The openings 114 are formed so that an amount of outside air flowing from the openings 114 onto a region with high temperature in the temperature distribution illustrated in FIG. 3 becomes greater. FIG. 4A is a schematic diagram illustrating the arrangement of the openings 114 according to the first exemplary embodiment. The plurality of openings 114 having a circular shape with a diameter of 2.5 mm is arranged more densely at positions closer to the center side of the accommodating unit 110. Center-to-center distances L1 to L6 of the openings become gradually shorter toward the center from the end portion.

In addition, the arrangement method of the openings 114 is not limited to the above-described example. As illustrated in FIG. 4B, the openings 114 may be arranged in such a manner that the arrangement density of the plurality of openings 114 is uniform, and the openings 114 arranged closer to the center side of the accommodating unit 110 has larger areas. In FIG. 4B, a plurality of rectangular openings 114 is formed with being arranged at an equal pitch. As for the dimension of each of the openings 114, the height is constant at D4=5 mm, and widths are D1=10 mm, D2=30 mm, and D3=40 mm. Accordingly, the openings arranged closer to the center has greater amount of air flowing into the accommodating unit 110.

In addition, as illustrated in FIG. 4C, the opening 114 can be formed of a single opening, and formed so that the width of the opening 114 becomes larger at positions closer to the center side of the accommodating unit 110. That is, the opening 114 is only required to be formed so that an amount of air flowing from the opening 114 into the accommodating unit 110 increases toward the center side of the accommodating unit 110. In other words, the opening 114 is provided so that its fluid resistance decreases toward the center side of the accommodating unit 110.

In addition, it is desirable to form the opening 114 so that fluid resistance from the opening 114 to the exhaust fan 112 becomes substantially equal to fluid resistance from the openings 113 and 115 to the exhaust fan 112. If a large difference is generated among these fluid resistances, air becomes harder to flow into a path with high fluid resistance. By setting the respective fluid resistances from the openings to the exhaust fan 112 to be substantially equal, air flows from the openings into the accommodating unit 110.

In the first exemplary embodiment, since the exhaust fan 112 is arranged on the upper side of the accommodating unit 110, a path from the opening 114 to the exhaust fan 112 is shorter than a path from the opening 113 or 115 to the exhaust fan 112. Thus, by setting the total area of the openings 114 to be smaller than the total area of the openings 113 and 115, air can be caused to flow into the accommodating unit 110 from the openings 113, 115, and 114.

The flow of air in the first exemplary embodiment will be described using FIG. 1. The exhaust fan 112 exhausts air within the accommodating unit 110 to the outer side. As a result, air pressure in the accommodating unit 110 becomes negative pressure as compared with that on the outer side of the accommodating unit 110. Outside air accordingly flows in from each opening. As indicated by a black arrow in FIG. 1, air having flowed in from the opening 113 goes upward within the accommodating unit 110, and reaches the exhaust fan 112 to be exhausted. Air having flowed in from the opening 115 similarly goes upward within the accommodating unit 110, and reaches the exhaust fan 112 to be exhausted, which is not illustrated in FIG. 1.

Air flowing from the opening 114 into the accommodating unit 110 goes downward from the upper side of the accommodating unit 110 toward the exhaust fan 112, and reaches the exhaust fan 112. At this time, air having flowed in from the opening 114 can transfer air on the upper side of the accommodating unit 110 to the exhaust fan 112 to exhaust the air. Air flowing in from the opening 114 is supplied from the opening 116 to the opening 114 through a tunnel-shaped space. In addition, air flowing in from the opening 114 can be supplied not only from the opening 116 but also from, for example, a gap between the upper surface of the accommodating unit 110 and the frame 10.

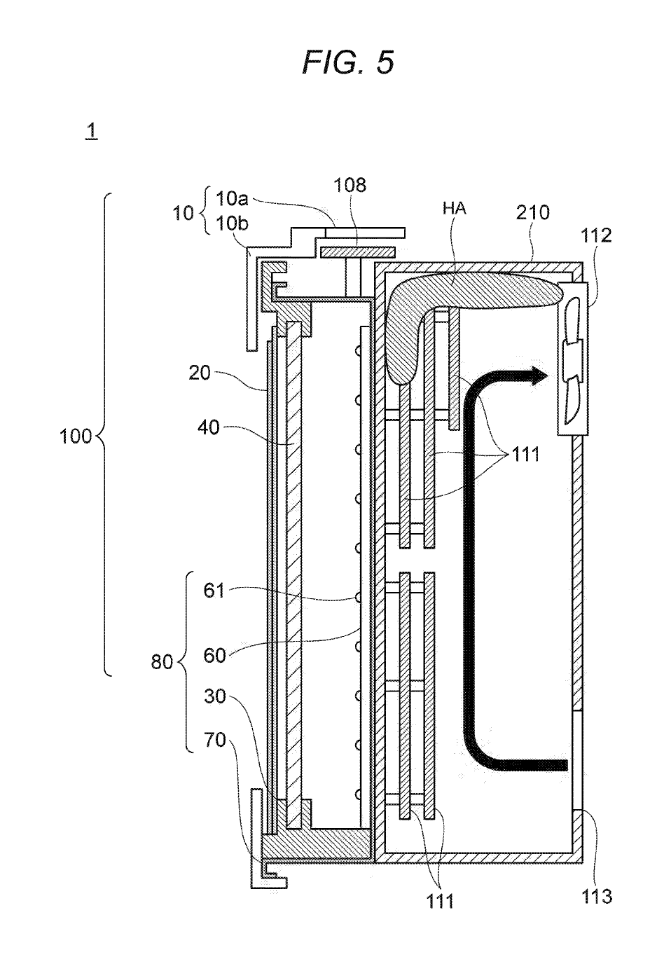

FIG. 5 is a cross-sectional view illustrating a display apparatus 1 not provided with an opening 114, as a comparative example of the first exemplary embodiment. The constituent elements assigned the same reference numerals as those in FIG. 1 are similar to those in FIG. 1. Thus, the description thereof will be omitted. An accommodating unit 210 accommodates the circuit boards 111, and is arranged on the back surface of the display unit 100. The exhaust fan 112 arranged on the back surface of the accommodating unit 210 exhausts air within the accommodating unit 210 to the outer side of the accommodating unit 210. The opening 113 is provided in the back surface of the accommodating unit 210, on the lower side of a position on the accommodating unit 210 where the exhaust fan 112 is arranged. In contrast to the first exemplary embodiment, the accommodating unit 210 is not provided with the opening 114 in the comparative example.

In the comparative example, the flow of air within the accommodating unit 210 is indicated by a black arrow in FIG. 5. Air having flowed in from the opening 113 provided on the lower side of the exhaust fan 112 of the accommodating unit 210 reaches the exhaust fan 112 from the lower side of the accommodating unit 210 as indicated by the black arrow in FIG. 5. Meanwhile, outside air does not flow into a hatched region HA illustrated in FIG. 5. Air in the region HA accordingly becomes harder to be exhausted from the exhaust fan 112.

In the air in the region HA, heated air easily stagnates as illustrated in FIG. 3. Thus, in the comparative example, heated air within the accommodating unit 210 is harder to be exhausted more than that in the first exemplary embodiment. The heated air stagnating in the region HA of the accommodating unit 210 may cause the malfunction or the like of the circuit boards 111 provided near the region HA.

According to the first exemplary embodiment, heated air stagnating in the upper part of the accommodating unit 110 is exhausted on the upper side of the arrangement position of the exhaust fan 112 of the accommodating unit 110, by outside air having flowed in from the opening 114 provided on the front surface of the accommodating unit 110. Consequently, a sufficient heat exhaust effect can be obtained over the entire accommodating unit.

In addition, by forming the opening 114 so that fluid resistance decreases toward the center, a greater amount of outside air can be caused to flow onto a high-temperature region of the accommodating unit 110. This can increase a heat exhaust effect, and suppress temperature rise in the accommodating unit 110.

In addition, since the opening 114 is communicated with the opening 116 provided on the side surface of the display apparatus 1, and air is drawn in from the opening 116, dirt or the like adhering to the display apparatus 1 can be prevented from being drawn into the accommodating unit 110.

### Second Exemplary Embodiment

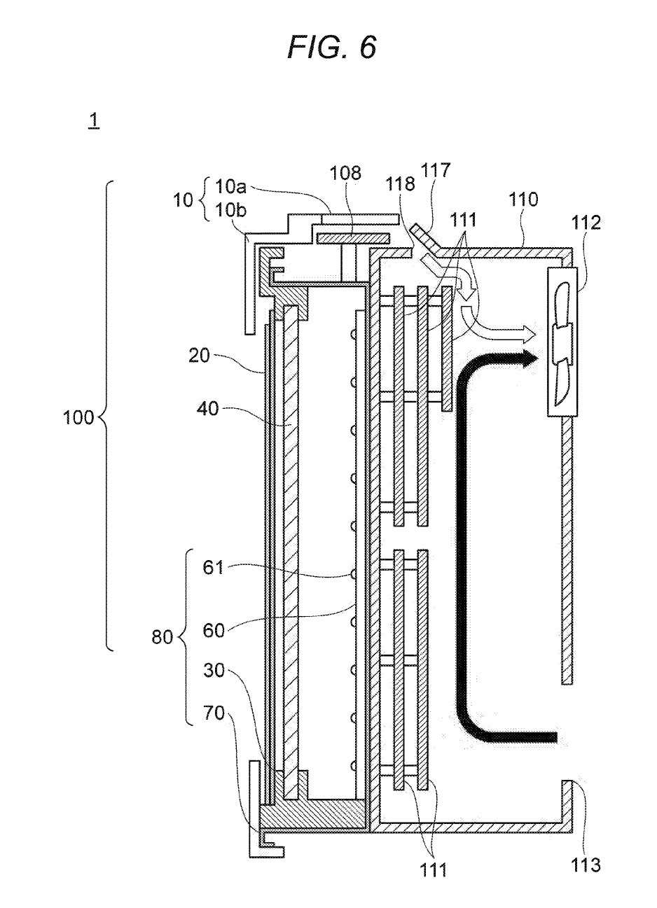

FIG. 6 is a cross-sectional view of a display apparatus 1 according to a second exemplary embodiment. The constituent elements assigned the same reference numerals as those in the first exemplary embodiment are similar to those in the first exemplary embodiment. Thus, the description thereof will be omitted. In the second exemplary embodiment, an opening 118 is provided in the upper surface of the accommodating unit 110. In addition, a blade plate 117 is provided so as to cover the upper side of the opening 118. By providing the blade plate 117, foreign substances such as dirt drifting in the outside air can be prevented from getting into the accommodating unit 110.

The flow of air within the accommodating unit 110 in the second exemplary embodiment will be described using FIG. 6. The exhaust fan 112 exhausts air within the accommodating unit 110 to the outer side. As a result, air pressure in the accommodating unit 110 becomes negative pressure as compared with that on the outer side of the accommodating unit 110. Outside air accordingly flows in from each opening. As indicated by a black arrow in FIG. 6, air having flowed in from the opening 113 goes upward within the accommodating unit 110, and reaches the exhaust fan 112 to be exhausted.

As indicated by a white arrow in FIG. 6, air having flowed in from the opening 118 passes through the upper part of the accommodating unit 110, and reaches the exhaust fan 112 to be exhausted. With this configuration, air heated due to the driving of a light source board in the upper part of the accommodating unit 110 is exhausted by the exhaust fan 112.

According to the second exemplary embodiment, heated air stagnating in the upper part of the accommodating unit 110 is exhausted on the upper side of the arrangement position of the exhaust fan 112 of the accommodating unit 110, by outside air having flowed in from the opening 118 provided in the upper surface of the accommodating unit 110. Consequently, a sufficient heat exhaust effect can be obtained over the entire accommodating unit. In addition, since the opening for drawing in outside air is provided on the upper surface, when a plurality of display apparatuses 1 is horizontally connected to be used, outside air can be drawn into the upper part of the accommodating unit 110.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2015-132154, filed Jun. 30, 2015, which is hereby incorporated by reference herein in its entirety.

What is claimed is:

1. A display apparatus comprising:
a display unit configured to display an image;
an accommodating unit arranged on a back surface side of the display unit, and configured to accommodate a first circuit board for driving the display unit; and
an exhaust means arranged on a back surface side of the accommodating unit,
wherein the accommodating unit includes a first opening through which air flows in from an outer side of the accommodating unit, and
wherein the first opening is provided so that an amount of air having flowed in through the first opening and flowing on an upper side of the first circuit board becomes greater than an amount of air having flowed in through the first opening and flowing on a lower side of the first circuit board.

2. The display apparatus according to claim 1, wherein the first opening is provided on a front side of the exhaust means in the accommodating unit.

3. The display apparatus according to claim 1, wherein the first opening is provided on an upper side of the exhaust means in the accommodating unit.

4. The display apparatus according to claim 1, wherein the first opening is provided on a front side of the first circuit board in the accommodating unit.

5. The display apparatus according to claim 1, wherein the first opening is provided on an upper side of the first circuit board in the accommodating unit.

6. The display apparatus according to claim 1, wherein a width of the first opening becomes wider toward a center side in a horizontal direction of the accommodating unit.

7. The display apparatus according to claim 1, wherein a plurality of the first openings is provided on a front surface of the accommodating unit.

8. The display apparatus according to claim 7, wherein the plurality of first openings is provided more densely at a position closer to a center side of the accommodating unit.

9. The display apparatus according to claim 7, wherein, among the plurality of first openings, an area of an opening is larger at a position closer to a center side of the accommodating unit.

10. The display apparatus according to claim 1, wherein the accommodating unit includes a second opening provided on a lower side of a position where the exhaust means is provided in the accommodating unit.

11. The display apparatus according to claim 1, further comprising a frame formed in a frame shape covering a peripheral region of a front surface and a side surface of the display unit,
wherein the first opening is provided on a front surface of the accommodating unit, and
wherein the first opening is communicated with a third opening provided in the frame.

12. The display apparatus according to claim 11,
wherein the third opening is provided in a side surface of the frame, and
wherein the first opening is communicated with the third opening through a flow path formed by the frame, an upper surface of the display unit, and a front surface of the accommodating unit.

13. The display apparatus according to claim 11, wherein a second circuit board for driving the display unit is arranged inside the flow path.

14. The display apparatus according to claim 1,
wherein the display unit includes:
a display panel for displaying an image; and
a light source unit arranged on the back surface side of the display panel, for irradiating the display panel with light.

15. The display apparatus according to claim 1,
wherein the first circuit board includes:
a panel control board for controlling the display panel;
a light source control board for controlling the light source unit; and
a power board for supplying power to the panel control board and the light source control board.

16. A display apparatus comprising:
a display unit configured to display an image;
a circuit board arranged on a back surface side of the display unit, and configured to drive the display unit;
an accommodating unit arranged on the back surface side of the display unit, and configured to accommodate the circuit board;
an exhaust means arranged on a back surface side of the accommodating unit;
a first opening provided so as to penetrate through the accommodating unit and communicate an inner side and an outer side of the accommodating unit, on an upper side of a position on the accommodating unit where the exhaust means is arranged; and
a second opening provided so as to penetrate through the accommodating unit and communicate an inner side and an outer side of the accommodating unit, on a lower side of the position on the accommodating unit where the exhaust means is arranged,
wherein the first opening is provided in at least either one of a front surface and an upper surface of the accommodating unit.
